(19) United States
(12) Patent Application Publication
(10) Pub. No.: US 2006/0079610 A1
(43) Pub. Date: Apr. 13, 2006

(54) Salt-like reaction products of hals derivatives and phosphor-cntaining organic acids for the stabilisation of polymeric materials

(76) Inventor: Peter Staniek, Binzen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/546,503

(22) PCT Filed: Feb. 19, 2004
(86) PCT No.: PCT/IB04/00508

§ 371 Date: Aug. 19, 2005

(30) Foreign Application Priority Data
Feb. 21, 2003 (EP) 03003939.0

(51) Int. Cl. C08K 5/34

(52) U.S. Cl. 524/99

(57) ABSTRACT

This invention relates to salt reaction products resp. premanufactured mixtures of compounds, which contain one or more groups of formula (Ia) to (Ic), 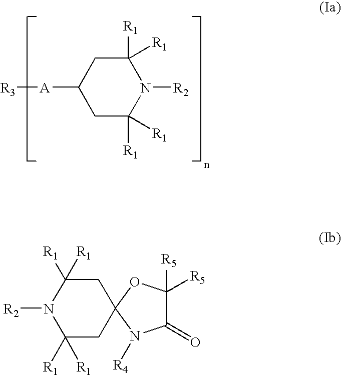
reaction products of 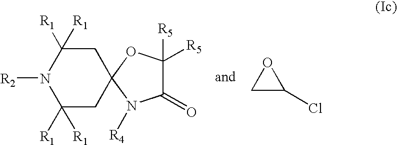
and organophosphorus acids resp. their derivatives, which contain one or more groups of formula (II), 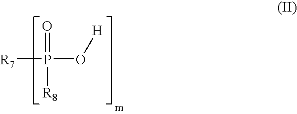 wherin the symbols have the meanings as given in claim 1 of the application. The invention further relates to a process for the preparation of saltlike reaction products and premanufactured mixtures. The saltlike reaction products and premanufactured mixtures can be used for stabilisation of polymers, in particularly polar polymers such as polyamides and polyesters, and for the improvement of the processing properties, heat stability, colour, gloss, surface and mechanical properties of these polymers.

The present invention relates to new saltlike reaction products respectively premanufactured mixtures of compounds selected from the group of sterically hindered amine light stabilisers (HALS compounds) with organophosphorus acids or organophosphorus acid derivatives (organophosphorus acids and derivatives are in the following together called “organo P-acids”).

The saltlike products respectively mixtures are suitable for the heat and/or light stabilisation of polymer materials and are also suitable for the improvement of the processing and long term stability of polymers.

As known to the person skilled in the art, the stabilizing effect of HALS-compounds during exposition to mineral acids, for example originating from acid rain or from decomposition products of biocides or flame retardants, is dramatically reduced. This is considered to be mainly due to the formation of saltlike products of the HALS-compounds with mineral acids.

Surprisingly, it has now been found, that the products of the invention, although they have a saltlike character, are suitable for the stabilisation of polymers, in particular for the stabilisation of polar polymers, such as polyamide or polyester. Moreover, the products of the invention provide for an improvement of the processing properties, such as flowability during extrusion, injection molding or fiber spinning, for an improvement of colour, gloss, surface quality and/or the mechanical properties of the final product.

The HALS-compounds (I) are selected from the following general formulae (Ia) to (Ic): 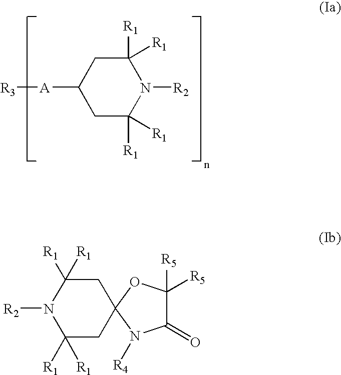
reaction products of 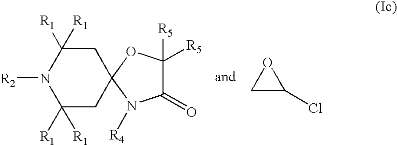
wherein the residues independently are selected from
A is —O— or —NR′—,
R′ is H, C₁-C₁₈-alkyl or a group selected from 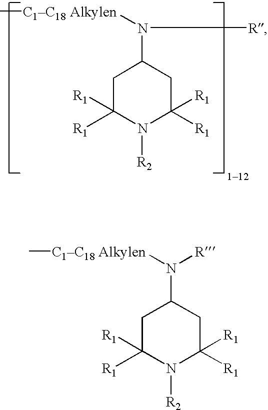
   with
R″ H, C₁-C₁₈-alkyl,
R′″ H, an aliphatic, cycloaliphatic, aromatic or heteroaromatic residue,
R₁ is C₁-C₁₈-alkyl, or two groups R₁ bound to the same carbon form a C₄-C₈-cycloalkyl residue,
R₂ is H or C₁-C₁₈-alkyl, C₇-C₁₈-alkylaryl,
R₃ is H, or a n-valent aliphatic, cycloaliphatic, aromatic or heteroaromatic residue,
R₄ is C₁-C₁₈-alkyl, —C(O)—C₁-C₁₈-alkyl or —C₁-C₈-alkyl —C(O)O—C₁-C₁₈-alkyl;
R₅ is H, C₁-C₁₈-alkyl, C₄-C₁₈-cycloalkyl or two groups R₅ bound to the same carbon form a C₄-C₁₈-cycloalkyl residue and
n a whole number >0.

The organo P-acids mentioned above are characterised by the general formula (II): 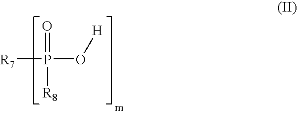
in which
independently of each other
R₇ is H, a m-valent aliphatic, cycloaliphatic, aromatic or heteroaromatic residue or —OR₉;
R₈ is H, an aliphatic, cycloaliphatic, aromatic or heteroaromatic residue or —OR₉;
R₉ is H, an aliphatic, cycloaliphatic, aromatic or heteroaromatic residue,
m is a whole number >0, preferably m is 1, 2, 3 or 4; more preferably 1 or 2.

The preferred groups R₁ are methyl. Also preferred are two groups R₁ bound to the same carbon atom forming a C₄-C₆-cycloalkyl ring.

Preferred groups R₂ are H, C₁-C₁₂-alkyl or benzyl.

Preferred groups R₃ are represented by the following residues
R₃ C₁-C₁₈-alkyl, C₁-C₁₈-alkylene, C₅-C₁₂-cycloalkyl, C₅-C₁₂-cycloalkylene, C₆-C₁₈-aryl, C₆-C₁₈-arylene, C₅-C₁₈-heteroaryl, C₅-C₁₈-heteroarylene, C₆-C₃₆-arylalkyl, C₆-C₃₆-arylalkylene, C₆-C₃₆-alkylaryl,C₆-C₃₆-alkylarylene and the residue 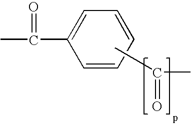
   where p represents a whole number between 1-4.

Preferred groups R₇ , R₈ , R₉ are C₁-C₁₈-alkyl, C₁-C₁₈-alkylene, C₅-C₁₂-cycloalkyl, C₅-C₁₂-cycloalkylene, C₆-C₁₈-aryl, C₆-C₁₈-arylene, C₅-C₁₈-heteroaryl, C₅-C₁₈-heteroarylene, C₆-C₃₆-arylalkyl, C₆-C₃₆-arylalkylene, C₆-C₃₆-alkylaryl,C₆-C₃₆-alkylarylene.

Preferred embodiments of the invention are saltlike compounds (III) with the general formulae (IIIa) to (IIIc) 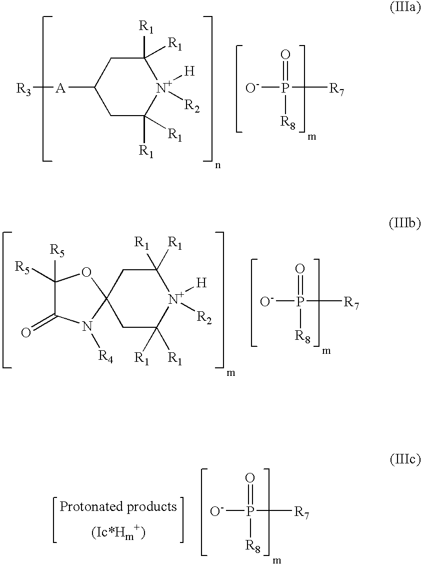
wherein n and m are greater than zero and the other substituents are defined as above.

Compounds of formulae (IIa) to (IIIc) comprising polyvalent substituents R₃ or R₇, may optionally comprise further groups of formula (I a) and/or (II).

Formula (IV) represents a particularly preferred candidate of the compound (III) 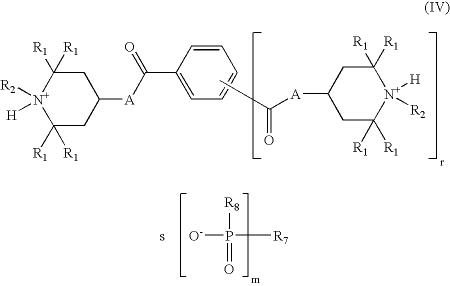
in which
r is a whole number between 0 and 3,
s represents (r+1)/m and
the other residues have the meanings given above,

Formula (V) represents the most preferred candidate of the compound (III) 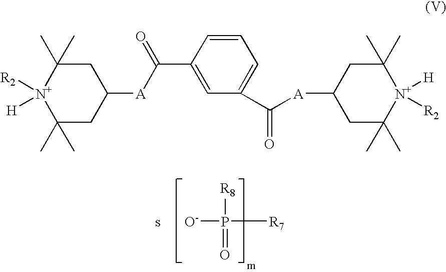
wherein r is 1 and
wherein the residues are the same as described above.

The products of the invention can be prepared in a reaction of one or more HALS-compounds (I) with one or more organo P-acids (II), where, depending on the molar ratio of the reaction partners and the reaction conditions, full- or hemi-amine salts of organo P-acids are formed. These salts show to some extent a considerably higher solubility in water or lower alcohols.

The products of the invention can be synthesised in solvents, preferrably in water or lower alcohols, or they can be synthesised in the melt. The obtained solutions can either be used directly or the products can be isolated by removal of the solvent. The resulting solids can be used in a subsequent process, optionally after further finishing.

The application of the products of the invention in polycondensation polymers like polyamide 6.6, PET or similar types, which are produced from a di-acid and a di-amino- or a diol component respectively, are particularly advantageous, as the products of the invention are easily and homogeneously dispersed in the reaction mixture during the polycondensation reaction due to their good solubility. The HALS-compounds themselves on the other hand are less soluble due to their hydrophobic character and therefore are more difficult to be homogeneously dispersed.

Other members of the group of products of the invention are better suited for the use in polymer melt processing due to their lower polarity. It was found that the preferred properties can be influenced by the selection of the components (I) and (II) within a wide range.

A further object of the invention are premanufactured mixtures of compounds—so-called “blends” in the plastic industry—consisting of the components (I) and (II) in a selected molar ratio. The products of the invention according to formula (III) can thereby be partly or completely formed already during the making of such blends, or during incorporation into the polymer mass, respectively during incorporation into the raw materials. The latter can be for example ε-Caprolactam (for PA6), AH-Salt-solution (for PA6.6) or precondensates from di-acids and dioles (for polyester).

As already known to the skilled person, such saltlike products respectively mixtures can also be formed by the use of HALS-compounds during the polycondensation and may disappear during continued polycondensation.

The premanufactured mixtures (blends) of the present invention are well defined with selected molar ratios. They are prepared by technical processes applicable also on large scale, which depending on the reaction conditions, already may partly form compounds of formula (III). Such blends, containing the appropriate amounts of component (I) and (II), may be added to the polycondensate. These premanufactured mixtures can be obtained from the melt (drop granulation techniques, prilling, extrusion, etc.), by compacting (roller compactors, tabletting, briquetting, press granulation, etc.), by granulation processes (spraying, fluidized bed granulation, drum granulation, etc.) or just by simple mixing.

The HALS-compounds, as well as the organo P-acids, can be mono- or oligofunctional. Preferred are HALS-compounds with one HALS-group and difunctional organo P-acids, HALS compounds with two or more HALS-groups and difunctional organo P-acids or HALS-compounds with two or more HALS-groups and monofunctional organo P-acids. Depending on the requirements, the molar ratio of the HALS-groups and the organo P-acid groups can be between 1:99 and 99:1, preferably between 40:60 and 60:40, and more preferably between 45:55 and 55:45 and most preferably the ratio is equimolar (50:50).

Preferred organo P-acids of formula (II) are C₁-C₁₈alkyl phosphinic acids, di-(C₁-C₁₈ alkyl)phosphinic acids, C₅-C₁₈cycloalkyl phosphinic acids, Di(C₅-C₁₈cycloalkyl) phosphinic acids, C₆-C₁₈aryl phosphinic acids, di-(C₆-C₁₈aryl) phosphinic acids, C₇-C₃₆alkylaryl phosphinic acids, C₇-C₃₆arylalkyl phosphinic acids, di-(C₇-C₃₆alkylaryl) phosphinic acids, di-(C₇-C₃₆arylalkyl) phosphinic acids, C₁-C₁₈alkylen bisphosphinic acids, C₁-C₁₈alkyl phosphonic acids, C₁-C₁₈alkyl phosphonic acids monoester, C₅-C₁₈cycloalkyl phosphonic acids, C₅-C₁₈cycloalkyl phosphonic acids monoester, C₆-C₁₈aryl phosphonic acids, C₆-C₁₈aryl phosphonic acids monoester, C₇-C₃₆alkylaryl phosphonic acids, C₇-C₃₆alkylaryl phosphonic acids monoester, C₁-C₁₈alkylen-bis phosphonic acids, acidic phosphate ester of the type (OR₉)—P(O)(OH)₂ oder (OR₉)₂—P(O)OH.

More preferred organo P-acids of formula (II) are C₁-C₁₂alkyl phosphinic acids, di-(C₁-C₁₂alkyl) phosphinic acids, C₆-C₁₂cycloalkyl phosphinic acids, di-(C₆-C₁₂cycloalkyl) phosphinic acids, C₆-C₁₂aryl phosphinic acids, di-(C₆-C₁₂aryl) phosphinic acids, C₇-C₁₈alkylaryl phosphinic acids, di-(C₇-C₁₈alkylaryl) phosphinic acids, C₁-C₁₂alkylen bis-phosphinic acids, C₁-C₁₂alkyl phosphonic acids, C₁-C₁₂alkyl phosphonic acids monoester, C₆-C₁₂aycloalkyl phosphonic acids, C₆-C₁₂cycloalkyl phosphonic acids monoester, C₆-C₁₂aryl phosphonic acids, C₆-C₁₂aryl phosphonic acids monoester, C₇-C₁₈alkylaryl phosphonic acids, C₇-C₁₈alkylaryl phosphonic acids monoester, C₁-C₁₂alkylen bis-phosphonic acids, acidic phosphate ester of the type (OR₉)—P(O)(OH)₂ or (OR₉)₂—P(O)OH.

Especially preferred organo P-acids of formula (II) are methyl phosphinic acid, dimethyl phosphinic acid, methyl ethyl phosphinic acid, ethyl phosphinic acid, diethyl phosphinic acid, propyl phosphinic acid, di-propyl phosphinic acid, butyl phosphinic acid, dibutyl phosphinic acid, hexyl phosphinic acid, dihexyl phosphinic acid, octyl phosphinic acid, dioctyl phosphinic acid, cyclohexyl phosphinic acid, dicyclohexyl phosphinic acid, phenyl phosphinic acid, diphenyl phosphinic acid, tolyl phosphinic acid, ditolyl phosphinic acid, xylyl phosphinic acid, dixylyl phosphinic acid, biphenyl phosphinic acid, di-biphenyl phosphinic acid, methylene bis-phosphinic acid, ethylene bis-phosphinic acid, 1,2-diethyl-ethylene bis- phosphinic acid, phenylethyl phosphinic acid, di(phenyl-ethyl) phosphinic acid, methyl phosphonic acid, ethyl phosphonic acid, methylene di-phosphonic acid, ethylene di- phosphonic acid.

Preferred HALS-compounds of formula (I) are 1,3-Benzoldicarboxamid, N,N′-bis-(2,2,6,6-tetramethyl-4-piperidinyl) (Nylostab® S-EED®), 2,2,4,4-Tetramethyl-7-oxa-3,20-diazadispiro[5.1.11.2]heneicosan-21-on (Hostavin® N 20), Poly[[6-[(1,1,3,3-tetramethylbutyl)amino]- 1,3,5-trazin-2,4-diyl][(2,2,6,6-tetramethyl-4-piperidinyl)imino]-1,6-hexandiyl-[(2,2,6,6-tetramethyl-4-piperidinyl)imino]], as well the reaction product (Hostavin® N 30) of 2,2,4,4-Tetramethyl-7-oxa-3,20-di-azadispiro[5.1.11.2]heneicosan-21-on (Hostavin® N 20) and epichlorohydrin.

The most preferred HALS-compound of formula (I) is 1,3-Benzoldicarboxamid-N,N′-bis(2,2,6,6-tetramethyl-4-piperidinyl) (which is commercially available from Clariant as Nylostab® S-EED®).

Examples for HALS-compounds resp. organo P-acids are mentioned in the following list. Each compound from one group (a or b) can be reacted resp. mixed with a compound of the other group (c or d)

a) HALS-compounds with one HALS-group
fattic acid-(C₁₆-C₁₈)-ester of 2,2,6,6-tetramethyl-piperidinol (Hostavin® 845)
3-Dodecenyl-1-(2,2,6,6-tetramethyl-4-piperidyl)pyrrolidin-2,5-dion (Sanduvor® 3055)
2,2,4,4-Tetramethyl-7-oxa-3,20-diaza-dispiro[5.1.11.2]-heneicosan-21-on (Hostavin® N 20)
2,2,4,4-Tetramethyl-20(β-Myristyl/lauryl-oxycarbonyl)-ethyl-7-oxa-3,20-diaza-dispiro[5.1.11.2]-heneicosan-21-on (Hostavin® N 24)
4-Hydroxy-2,2,6,6-tetramethylpiperidin
4-Amino-2,2,6,6-tetramethylpiperidin
4-Hydroxy-1,2,2,6,6-pentamethylpiperidin
4-Amino-1,2,2,6,6-pentamethylpiperidin
4-N-Butyl-amino-2,2,6,6-tetramethylpiperidin
N-Hydroxyethyl-4-hydroxy-2,2,6,6-tetramethylpiperidin

b) HALS-compounds with two HALS-groups
1,3-Benzoldicarboxamid,N;N′-bis(2,2,6,6-tetramethyl-4-piperidinyl) (Nylostab® S-EED®)

c) Difunctional organo P-acids
C₁-C₁₈-Alkylene bis-phosphinic acids
C₁-C₁₈-Alkylene bis-phosphonic acids

e) Monofunctional organo P-acids
Diphenylphosphinic acid
Phenylphosphinic acid
Diethylphosphinic acid
Ethylphosphinic acid

Preferred polymers for the application of the products of the invention are polyamides, like polyamide 6, polyamide 11, polyamide 12, polyamide 4.6, polyamide 6.6, polyamide 6.9, polyamide 6.10, polyamide 6.12, polyamide 12.12, and polyester like terephthalic acid/alkyldiol based polyester (for example PET, PBT), aliphatic polyester, aromatic polyester, liquid crystal polyester, polyetherester, and polycarbonates as well as their blends and copolymers.

Especially preferred polymers are polyamide 4.6, polyamide 6.6, polyamide 6, polyamide 11, Polyamide 12, polyethylenterepthalate (PET), polybutylen-terephthalate (PBT), polycarbonate, their copolymers and blends.

The addition of the products of the invention can either take place before or during the preparation of the polymer as well as during further processing steps. The products can be used as solids (powder or blend), as solutions (in inert or reactive solvents), as masterbatch or as a concentrate and, in case of un-decomposed melting compounds, also as melt.

Of particular advantage is the addition in a free flowing preparation form, as obtained for example from the melt (drop granulation techniques, prilling, extrusion, etc.) by compacting (roller compactors, tabletting, briquetting, press granulation, etc.) or by granulation processes (spraying, fluidized bed granulation, drum granulation, etc.). These manufactured forms also comprise mixtures of the products of the invention or mixtures with other polymer additives or colorants known in the art (blends). Apart of the products of the invention, other additives or colorants can be added to the polymer before, simultaneously or afterwards, including also blends containing the products of the invention.

Examples of such other additives are lightstabilizers (further HALS-compounds, UV-absorbers, excited state quenchers), phosphor- or sulphur based processing stabilizers, antioxidants (phenol- or amine based), antistatics, nucleating agents, clarifiers, flame retardants, reinforcing materials (e.g. mineral fillers, glass fibers, hollow glass spheres, carbon fibers, nanoscale reinforcing materials (e.g. nanoclays, carbon nanotubes), lubricants, anti block agents, colorants (pigments and colorants) etc.

The production and application of the products of the invention are shown in the following examples:

### EXAMPLE 1

### Synthesis of the Salt from Nylostab® S-EED® and Diphenylphosphinic Acid

74.2 g of diphenylphosphinic acid are added to a suspension of 75.3 Nylostab® S-EED® in 250 ml ethanol and stirred at 80° C. for 2 h. The solvent is removed under vacuum and the colorless, crystalline presscake is dried at 80° C. in vacuum.

### EXAMPLE 2-3

Application of the invented compound in polyamides

General Processing Recipe

The invented compounds are homogenised together with the polyamide powder on a Collin single screw extruder at the mentioned temperature of use. The current of the extruder motor (equivalent to torque), the pressure at the die, the mass temperature as well as the throughput are registered at constant machine settings.

A lower motor current and/or an increased throughput are important data, as they directly influence the production costs. A constant pressure at the die induces a good intake and feeding property and is of importance for the reproducible preparation of end use articles, as for example, injection molding articles or very uniform fibres. An increased pressure besides induces less damage of the polyamide through chain destruction during the process; the added additive contributes in this case to the polymer stability.

The results of the application obtained are summarised in the following table.

| | | | | Process | average motor | Pressure | Throughput |
|---|---|---|---|---|---|---|---|
| Example | Compound | Conc. | Polymer | Temperature | current [A] | [bar] | [kg/h] |
| 2 | None | 0% | PA 6.6 | 270 | 3.2 ± 2.0 | 4.6 ± 1.3 | 2.34 |
| 3 | EXAMPLE 1 | 0.1% | PA 6.6 | 270 | 2.8 ± 0.4 | 6.6 ± 1.3 | 3.46 |

1. A saltlike reaction product formed by reacting one or more components of formulae (Ia) to (Ic), 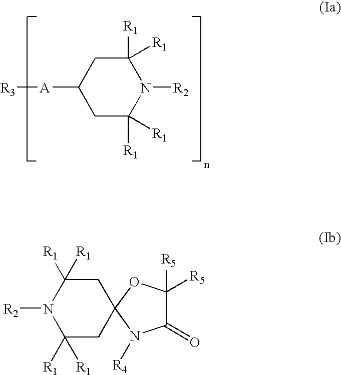
reaction products of 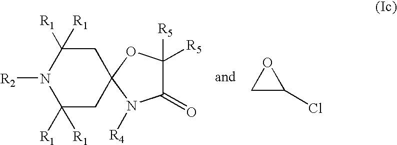
wherein independently of one another
A is —O— or —NR′—,
R′ is H, C₁-C₁₈-alkyl or a group selected from the group consisting of 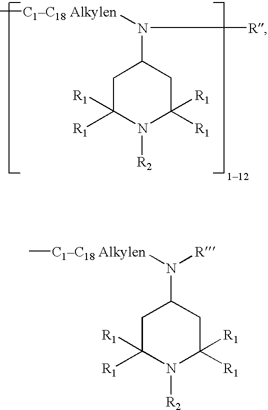
wherein
R″ is H, or C₁-C₁₈-alkyl,
R′″ is H, an aliphatic, cycloaliphatic, aromatic or heteroaromatic residue,
R₁ is C₁-C₁₈-alkyl, or two groups R₁ bound to the same carbon form a C₄-C₈-cycloalkyl residue,
R₂ is H, C₁-C₁₈-alkyl, or C₇-C₁₈-alkylaryl,
R₃ is H, or a n-valent aliphatic, cycloaliphatic, aromatic or heteroaromatic residue,
R₄ is C₁-C₁₈-alkyl, —C(O)—C₁-C₁₈-alkyl or -C₁-C₈-alkyl —C(O)O—C₁-C₁₈-alkyl;
R₅ is H, C₁-C₁₈-alkyl, C₄-C₁₈-cycloalkyl or two groups R₅ bound to the same carbon form a C₄-C₁₈-cycloalkyl residue and
n is a whole number >0
and one or more organo P-acids of formula (II), 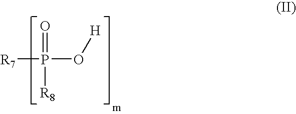
wherein independently of one another
R₇ is C₁-C₁₈-alkyl, C₁-C₁₈-alkylene, C₅-C₁₂-cycloalkyl, C₅-C₁₂-cycloalkylene, C₆-C₁₈-aryl, C₆-C₁₈-arylene, C₅-C₁₈-heteroaryl, C₅-C₁₈-heteroarylene, C₆-C₃₆-arylalkyl, C₆-C₃₆-arylalkylene, C₆-C₃₆-alkylaryl or C₆-C₃₆-alkylarylene;
R₈ is H, an aliphatic, cycloaliphatic, aromatic or heteroaromatic residue or —OR₉;
R₉ is H, an aliphatic, cycloaliphatic, aromatic or heteroaromatic residue
m is a whole number >0.

2. Saltlike reaction product according to claim 1 of the general formula (III) selected from the groups (IIIa) to (IIIc) 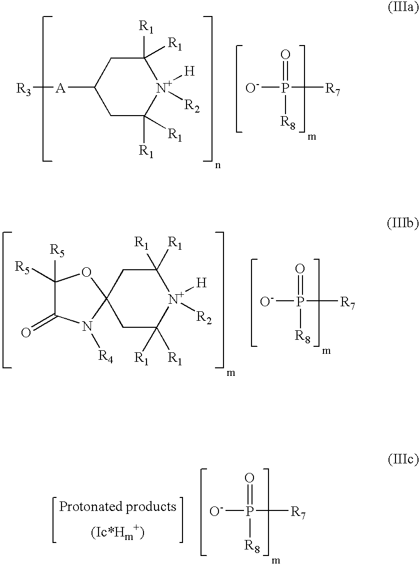
wherein
A, R₁, R₂, R₃, R₄, R₅, R₇, R₈, n and m are defined as in claim 1.

3. Saltlike reaction product according to claim 1 of the general formula (IV) 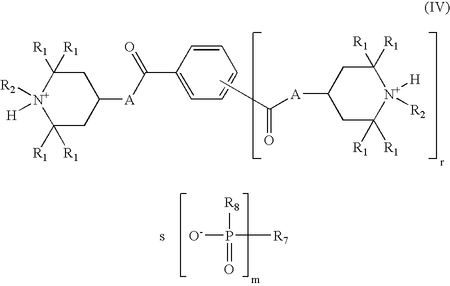
wherein
r is a whole number between 0 and 3,
s represents (r+1 )/m and
A, R₁, R₂, R₇, R₈ and m are defined as in claim 1.

4. Saltlike reaction product according to claim 1 of the general formula (V) 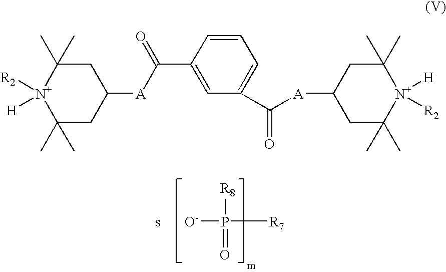
wherein
r is 1 and
s represents (r+1 )/m and
A, R₂, R₇, R₈ and m are defined as in claim 1.

5. Saltlike reaction product according to claim 1 wherein the molar ratio of the at least one or more components of formulae (Ia) to (Ic) to the one or more organo P-acids is 1:99 to 99:1.

6. Saltlike reaction product according to claim 1, wherein the one or more components of formulae (Ia) to (Ic) is selected from the group consisting of 1,3-Benzol-dicarboxamid, N,N′-bis(2,2,6,6-tetramethyl-4-piperidinyl); 2,2,4,4-Tetramethyl-7-oxa-3,20-diazadispiro-[5.1.11.2]heneicosan-21-on; Poly-[[6-[(1,1,3,3-tetramethylbutyl)amino]-1,3,5-triazin-2,4-diyl][(2,2,6,6-tetramethyl-4-piperidinyl)imino]-1,6-hexandiyl-[(2,2,6,6-tetramethyl-4-piperidinyl)imino]] and the reaction product of 2,2,4,4-Tetramethyl-7-oxa-3,20-diazadispiro-[5.1.11.2]heneicosan-21-on and epichlorohydrin.

7. Saltlike reaction product according to claim 1, wherein the one or more organo P-acids of formula (II) is selected from the group consisting of diphenylphosphinic acid, phenylphosphinic acid, diethylphosphinic acid, ethylphosphinic acid, ethylene-bis(ethylphosphinic acid) and ethylene-bis(ethylphosphonic acid).

8. Process for the preparation of a saltlike reaction product comprising the step of reacting one or more HALS-compounds of general formula (Ia) to (Ic). 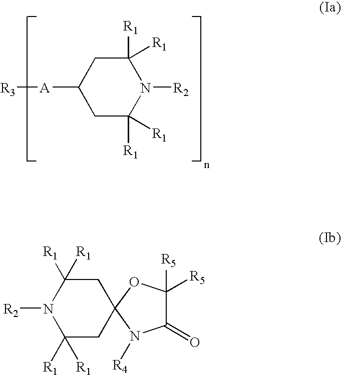
reaction products of 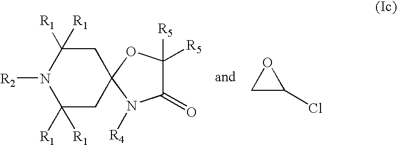
wherein independently of one another
A is —O— or —NR′—.
R′ is H, C₁-C₁₈-alkyl or a group selected from the group consisting of 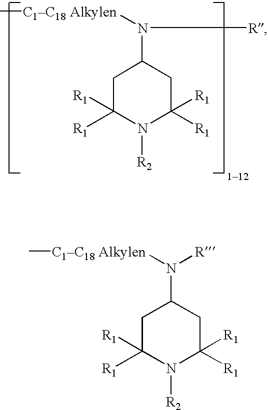
wherein
R″ is H, or C₁-C₁₈-alkyl,
R′″ is H, an aliphatic, cycloaliphatic, aromatic or heteroaromatic residue,
R₁ is C₁-C₁₈-alkyl, or two groups R₁ bound to the same carbon form a C₄-C₈-cycloalkyl residue,
R₂ is H, C₁-C₁₈-alkyl, or C₇-C₁₈-alkylaryl,
R₃ is H, or a n-valent aliphatic, cycloaliphatic, aromatic or heteroaromatic residue,
R₄ is C₁-C₁₈-alkyl, —C(O)—C₁-C₁₈-alkyl or -C₁-C₈-alkyl —C(O)O—C₁-C₁₈-alkyl;
R₅ is H, C₁-C₁₈-alkyl, C₄-C₁₈-cycloalkyl or two groups R₅ bound to the same carbon form a C₄-C₁₈-cycloalkyl residue and
n is a whole number >0
with one or more organo P-acids of formula (II), 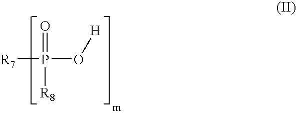
wherein independently of one another
R₇ is C₁-C₁₈-alkyl, C₁-C₁₈-alkylene, C₅-C₁₂-cycloalkyl, C₅-C₁₂-cycloalkylene, C₆-C₁₈-aryl, C₆-C₁₈-arylene, C₅-C₁₈-heteroaryl, C₅-C₁₈-heteroarylene, C₆-C₃₆-arylalkyl, C₆-C₃₆-arylalkylene, C₆-C₃₆-alkylaryl or C₆-C₃₆-alkylarylene;
R₈ is H, an aliphatic, cycloaliphatic, aromatic or heteroaromatic residue or —OR₉;
R₉ is H, an aliphatic, cycloaliphatic, aromatic or heteroaromatic residue
m is a whole number >0.

9. Process for the preparation of a premanufactured mixture, wherein the mixture is formed by the reaction of one or more HALS-compounds of formula (Ia) to (Ic). 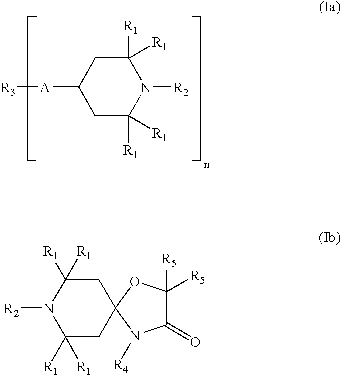
reaction products of 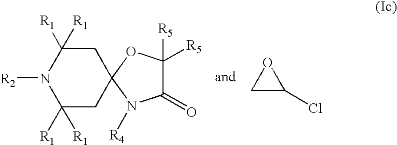
wherein independently of one another
A is —O— or —NR′—,
R′ is H, C₁-C₁₈-alkyl or a group selected from the group consisting of 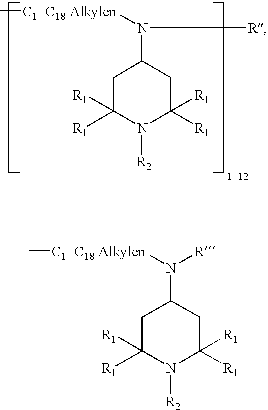
wherein
R″ is H, or C₁-C₁₈-alkyl,
R′″ is H, an aliphatic, cycloaliphatic, aromatic or heteroaromatic residue,
R₁ is C₁-C₁₈-alkyl, or two groups R₁ bound to the same carbon form a C₄-C₈-cycloalkyl residue,
R₂ is H, C₁-C₁₈-alkyl, or C₇-C₁₈-alkylaryl,
R₃ is H, or a n-valent aliphatic, cycloaliphatic, aromatic or heteroaromatic residue,
R₄ is C₁-C₁₈-alkyl, —C(O)—C₁-C₁₈-alkyl or -C₁-C₈-alkyl —C(O)O—C₁-C₁₈-alkyl;
R₅ is H, C₁-C₁₈-alkyl, C₄-C₁₈-cycloalkyl or two groups R₅ bound to the same carbon form a C₄-C₁₈-cycloalkyl residue and
n is a whole number >0
and one or more organo P-acids of formula (II) 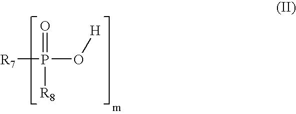
wherein independently of one another
R₇ is C₁-C₁₈-alkyl, C₁-C₁₈-alkylene, C₅-C₁₂-cycloalkyl, C₅-C₁₂-cycloalkylene, C₆-C₁₈-aryl, C₆-C₁₈-arylene, C₅-C₁₈-heteroaryl, C₅-C₁₈-heteroarylene, C₆-C₃₆-arylalkyl, C₆-C₃₆-arylalkylene, C₆-C₃₆-alkylaryl or C₆-C₃₆-alkylarylene;
R₈ is H, an aliphatic, cycloaliphatic, aromatic or heteroaromatic residue or —OR₉;
R₉ is H, an aliphatic, cycloaliphatic, aromatic or heteroaromatic residue
m is a whole number >0
comprising the step of preparing the mixture, wherein the preparing step includes one of obtaining the mixture from a melt, compacting the mixture, granulating the mixture or mixing the mixture.

10. A polymer stabilizer comprising at least one reaction as claimed in claim 1.

11. Saltlike reaction product according to claim 1, wherein the molar ratio of the at least one or more components of formulae (Ia) to (Ic) to the one or more organo P-acids is 40:60 to 60:40.

12. Saltlike reaction product according to claim 1 wherein the molar ratio of the at least one or more components of formulae (Ia) to (Ic) to the one or more organo P-acids is 45:55 to 55:45.

13. Saltlike reaction product according to claim 1 wherein the molar ratio of the at least one or more components of formulae (Ia) to (Ic) to the one or more organo P-acids is 50:50.

14. A saltlike reaction product made by the process of claim 8.

15. The polymer stabilizer according to claim 10, Use of saltlike reaction products or premanufactured mixtures according to claim 1, wherein the polymer to be stabilized is a polar polymer.

16. The polymer stabilizer according to claim 10, wherein the polymer to be stabilized is a polyamide or polyester.

17. The polymer stabilizer according to claim 10, wherein the polymer to be stabilized is a polyamide.
